(19) United States
(12) Patent Application Publication
(10) Pub. No.: US 2020/0411272 A1
(43) Pub. Date: Dec. 31, 2020

(54) DEVICE INCLUDING AN IONIZER

(71) Applicant: ATONARP INC., Minato-ku, Tokyo (JP)

(72) Inventors: Said BOUMSELLEK, Fremont, CA (US); Naoki TAKAHASHI, Tokyo (JP); Prakash Sreedhar MURTHY, Tokyo (JP)

(73) Assignee: ATONARP INC., Minato-ku, Tokyo (JP)

(21) Appl. No.: 16/976,516

(22) PCT Filed: Mar. 8, 2019
(86) PCT No.: PCT/JP2019/009407

§ 371 Date: Aug. 28, 2020

Related U.S. Application Data
(60) Provisional application No. 62/640,864, filed on Mar. 9, 2018.

(51) Int. Cl. H01J 27/20; H01J 1/20

(52) U.S. Cl. CPC H01J 27/205; H01J 49/10; H01J 1/20

(57) ABSTRACT

A device including an ionizer is disclosed. The ionizer comprises bulk bodies including one or more emitter materials and that is configured to at least partly depletable; and a heating unit that is configured to heat at least a part of the bulk bodies. The ionizer may comprise a electron emitter dispenser that is configured to exposes a limited part of the bulk bodies.

### TECHNICAL FIELD

The inventions generally relate to a device including an ionizer.

### BACKGROUND ART

In a publication US2017/0169981, a thermionic emission filament, a quadrupole mass spectrometer and residual gas analyzing method are disclosed. In this publication, a thermionic emission filament is disclosed that is capable of ensuring a long life and improving an analysis accuracy of a mass spectrometer using the thermionic emission filament. The thermionic emission filament includes a core member through which electric current flows and an electron emitting layer which is formed so as to cover a surface of the core member. The electron emitting layer is configured to have denseness for substantial gas-tight integrity to suppress corrosion of the core member.

### SUMMARY OF INVENTION

Filaments have been the workhorse electron emitter in several charged particle devices in numerous applications. They represent low cost low power options to generate a high flux of electrons. As conventionally introduced, the filament consists of a thin wire wound in the shape of a spring. The wire is brought to temperatures usually above 1000° C. by circulating an electrical current. Such temperature corresponds to the energy, also called work function, required to releasing electrons from the valence bond to the continuum. In the presence of high concentrations of oxidizing gases e.g. water and oxygen, an oxide layer is formed at the top surface of the wire which leads to an increase of the work function. To maintain a constant electron flux, such an increase in work function requires increasing the temperature and therefore accelerating the evaporation of the wire and thus limiting its lifetime. To extend the lifetime in such applications, Iridium wire coated with oxide emitters e.g. Thoria and Yttria may be used. However, the performance of coated wires degrades as coating is depleted through evaporation, sputtering away by ion bombardment, and chemical poisoning in the presence of corrosive gases. The lifetime of the coated filament is based on the evaporation rate or degradation of the coating materials and heater wire; both are temperature and ambient pressure dependent.

One of aspect of this invention is a device including an ionizer that comprises at least one bulk body including at least one electron emitter material and that is configured to at least partly depletable, and a heating unit that is configured to heat at least a part of the at least one bulk body. Depletable bulk body that includes electron emitter material provides an enormous supply source of the emitter material and a flux of electrons are generated by heating a part of bulk body to be depleted. According to this invention, a device including a long lifetime thermo-emission electron ionizer suitable for field applications can be supplied.

The ionizer may further comprise at least one electron emitter dispenser. Each electron emitter dispenser may be configured to exposes a limited part of the at least one bulk body. By dispensing a limited part of the bulk body for generating a flux of electrons, it becomes possible to provide continuous or intermittent supply of emitter materials by replenishing the reserves as that, evaporate, get sputtered by positive ions, and/or get poisoned by ambient corrosive gases. The replenishment of the emitter material may be performed on a mechanically extendable solid or array of bulk bodies.

The electron emitter dispenser may include a reservoir configured to hold the at least one bulk body and a propelling mechanism configured to expose a limited part of the at least one bulk body. The heating unit may be configured to heat the limited part of the at least one bulk body. The heating unit may be any type of heater that can heat the top surface layers of the bulk body to temperatures around or exceeding 1000° C., such as a ring type, coil type, sleeve type or using radiation e.g. IR or UV. The propelling mechanism may be configured to expose the limited part including a tip of the at least one bulk body. The heating unit may be configured to heat the tip of the at least one bulk body.

The device may further comprise a modular component for electron generation that includes at least one electron emitter dispenser and detection including circuitry for emission control of the electron generation. The modularized electron generator may be used as a standalone or as an add-on component.

The ionizer may further comprise an accelerating anode plate outfitted with a single or an array of apertures to supply electrons efficiently, for example to an ionization region. The ionizer may further comprise an ionization region where sampling gases are ionized with electrons generated by the at least one bulk body. The ionization region may include an anode and a magnet field to make long electron trajectory to improve the ionization efficiency. The ionizer may further comprise a holder configured to hold the at least one bulk body to prevent direct exposure of the sampling gases. Heavy ion damage due to the direct exposure of injected gas and generated ions to the bulk body can be suppressed. The ionizer may further comprise a holder configured to hold the at least one bulk body so that an end of the at least one bulk body is directed to the ionization region and another end of the at least one body is not directed to the ionization region so as to control the depleting or evaporating process of the bulk body.

The at least one bulk body may be sintered or dipped with powders of the at least one electron emitter material to form a large number of nano-emitters distributed in the at least one bulk body. Millions and more nano-emitters may be distributed uniformly in the bulk phase. The at least one bulk body may include at least one bulk cathode that includes a bulk body integrated with a coiled filament. The at least one bulk body may include a cylindrical like body, a rod like body or a wire like body.

The device may include an operating unit that is configured to operate the ionizer at various temperatures and/or various electron energies. One of aspect of the device may be a mass spectrometer or a mass analyzer that includes a mass filter region disposed next to the ionization region. The device may be a device including a mass spectrometer section.

Another aspect of this invention is a method comprising ionizing gasses using an ionizer that comprises at least one bulk body including at least one electron emitter material and a heating unit for heating at least a part of the at least one bulk body. The ionizing includes emitting thermal electrons (thermions) while allowing part of the at least one bulk body to deplete. By using bulk body like emitter material solid with allowing partly depleting, long time thermionic electron emission becomes possible even in severe conditions.

The ionizing of the method may include exposing a limited part of the at least one bulk body using the at least one electron emitter dispenser. The electron emitter dispenser holds the at least one bulk body and dispenses a limited part of the bulk body to allow the limited part of the bulk body to evaporate. The at least one electron emitter dispenser may include a structure to hold the at least one bulk body and a propelling mechanism that exposes the limited part of the at least one bulk body. The exposing of the method may include using the propelling mechanism of the emitter dispenser to advance the dispending of the at least one bulk body.

The ionizing of the method may include operating the ionizer at the same or different temperatures and electron acceleration voltages. The ionizing may include using at least one aperture for defining electron beams toward a sample gases ionization region. The method may comprise operating the ionizer as standalone device or interfaced with existing ion source providing electron acceleration voltages.

Yet another aspect of this invention is a computer program (program product) for a computer to operate a device including an ionizer that comprises at least one electron emitter dispenser for dispensing a limited part of at least one bulk body including at least one electron emitter. The computer program includes executable codes for performing at least one of steps of: (a) propelling the at least one bulk body at a certain rate which depends on the depletion rate of the bulk body; (b) propelling the at least one bulk body upon command; (c) propelling the at least one bulk body based on external information which indicates depletion of an exposed limited part of the at least one bulk body; (d) adjusting a temperature of the exposed limited part of the at least one bulk body to provide a constant flux of electrons; and (e) controlling at least one of a voltage of a surface of the at least one bulk body and a voltage of an accelerating anode to set or scan an electron energy generated by the at least one electron emitter dispenser. A non-transitory computer readable medium storing the above program (program product, software) for controlling and operating the device, or detecting and analyzing using the device is also included in this invention.

### BRIEF DESCRIPTION OF DRAWINGS

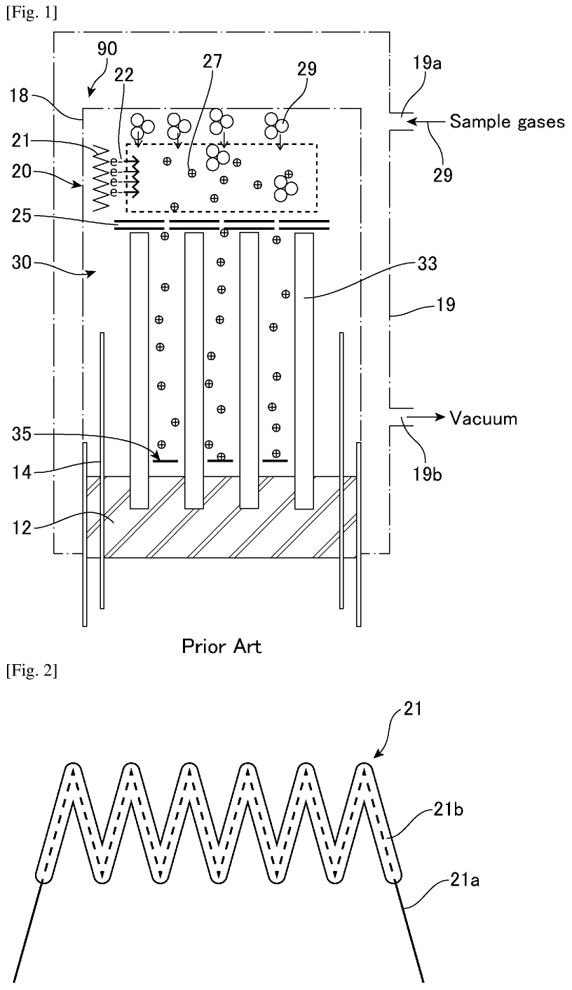

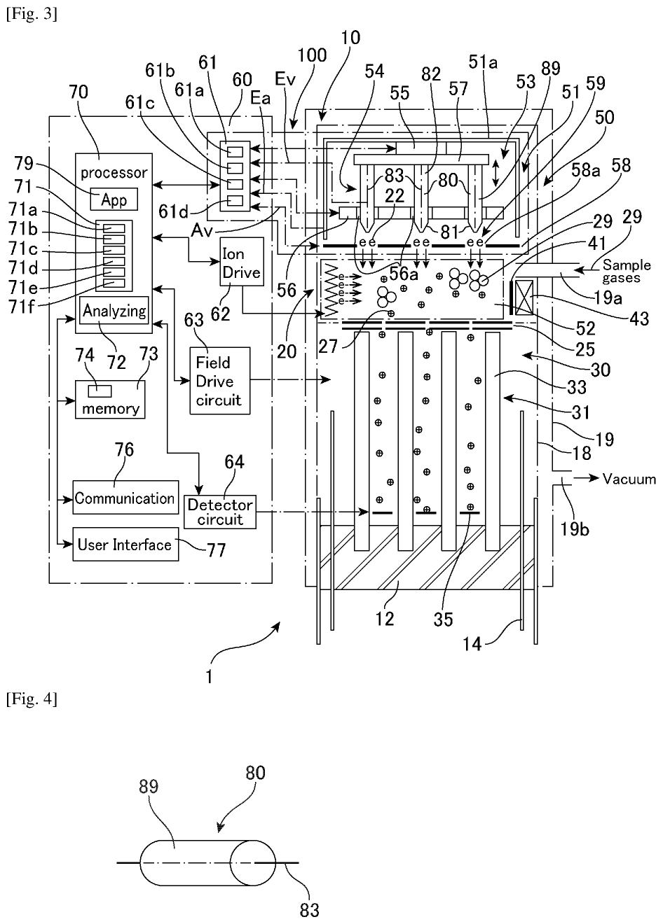

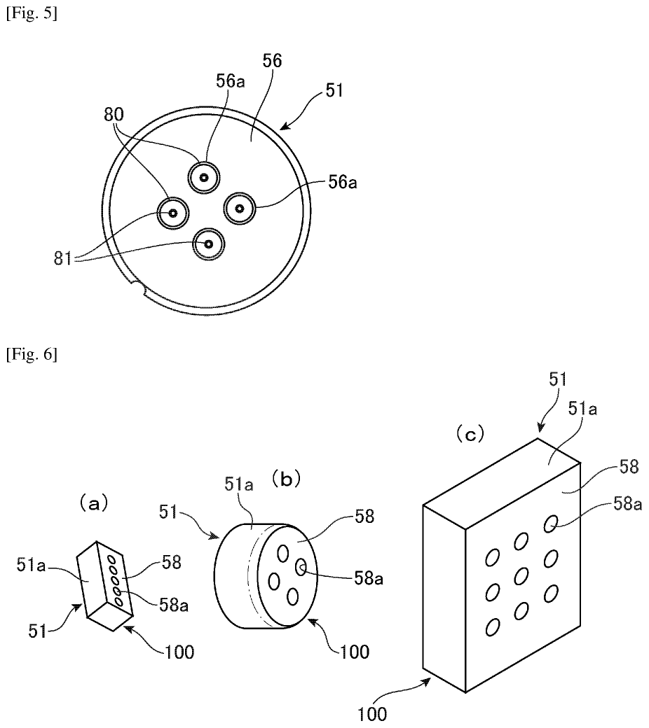

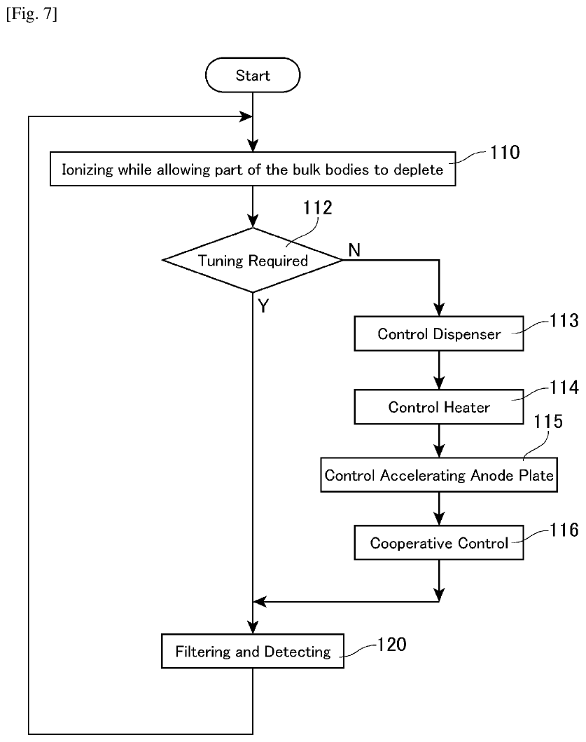

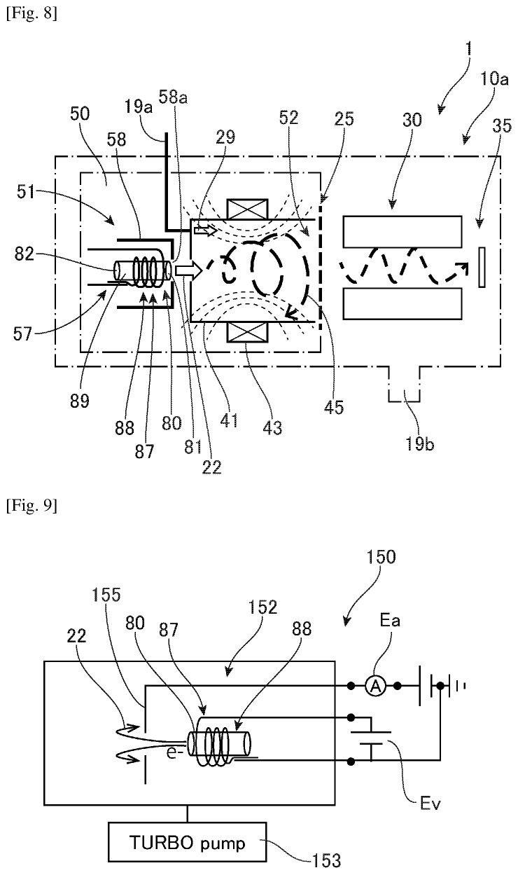

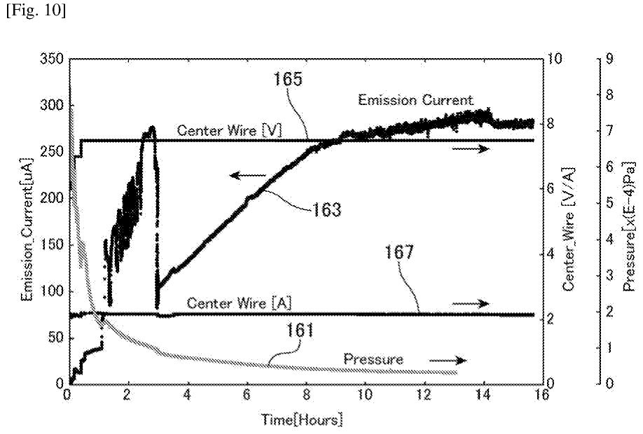

The embodiments herein will be better understood from the following detailed description with reference to the drawings, in which:

[FIG. 1]FIG. 1 illustrates an example of one of conventional mass analyzers as a prior art;

[FIG. 2]FIG. 2 illustrates an example of one of conventional filament emitters;

[FIG. 3]FIG. 3 illustrates one embodiment of a device in accordance with the invention;

[FIG. 4]FIG. 4 illustrates one embodiment of a bulk body in accordance with the invention;

[FIG. 5]FIG. 5 illustrates a front view of the dispenser that includes a 2×2 array of four bulk bodies in a matrix-like pattern;

[FIG. 6]FIG. 6 (a) to (c) show an electron generator in various embodiments for different ionizer geometries;

[FIG. 7]FIG. 7 is a flow diagram that illustrates a process for measurement using the device shown in FIG. 3;

[FIG. 8]FIG. 8 illustrates another one of embodiments of the device;

[FIG. 9]FIG. 9 illustrates one of test results using the bulk cathode; and

[FIG. 10]FIG. 10 shows electron emission recorded from a preferred embodiment of Yttria : Iridium (10:1) sintered laboratory prototype bulk cathode.

### DESCRIPTION OF EMBODIMENTS

FIG. 1 depicts a device referenced herein as Prior Art. The device shown on FIG. 1 is a miniature mass analyzer (mass spectrometer) 90 that includes a miniature quadrupole type mass filter 30 whereby rods 33 are aligned and held in a glass chassis 12. The mass filter 30 features an array of quadrupoles multiplexed to operate in parallel to partially recover signal loss due to miniaturization. Typical mass analyzer 90 is outfitted with a permanently assembled conventional dual filament 21 based electron impact ionizer 20, an electrostatic lens (source slit) 25, the mass filter 30, iron collectors 35, pins for electrical connection 14 and sensor housing 18 for housing these as one device or one piece. Typical sizes of housing 18 are about 1-2 cm in diameter and about 2-5 cm in length. The mass analyzer 90 can be inserted or installed in a small chamber 19, a pipe or a vessel that has an inlet 19a for supplying sample gases 29 and an outlet 19b for evacuating the chamber 19 by a vacuum pump (not shown). In the mass analyzer 90, molecules of sample gases are ionized by the electrons 22 emitted from the filament 21 of the ionizer 20. The ions 27 are introduced via the electrostatic lens 25 into the quadrupole mass filter 30 that includes, for example, 4×4 array of rods 33 in a matrix-like pattern. Separated ions by the mass filter 30 are reached on the ion collector, for example, faraday ion collector 35 and detected as an ion current.

Typical ion collector 35 is faraday ion collector. Instead of the faraday collector, electron multipliers (EMs) and/or microchannel plates (MCPs) may be used. Both filaments and EMs have limited lifetimes, due to the degradation of the surface layer (active element in the case of filaments and resistive coating in the case of EMs) making low cost and reliable long-term dependability a challenge.

FIG. 2 depicts a conventional filament emitter 21 that consists of a base metal wire 21a and emitter material 21b coated over the wire 21a via electrophoresis process. Filaments 21 have been the workhorse electron emitter in several charged particle devices in numerous applications. They represent low cost low power options to generate a high flux of electrons. As conventionally introduced, the filament 21 consists of a thin wire 21a wound in the shape of a spring. The wire 21a is brought to temperatures usually above 1000° C. by circulating an electrical current. Such temperature corresponds to the energy, also called work function, required to releasing electrons from the valence bond to the continuum. Types of wires 21a include with different work functions including Tungsten, Rhenium etc.

In the presence of high concentrations of oxidizing gases e.g. water and oxygen, an oxide layer is formed at the top surface of the wire 21a which leads to an increase of the work function. To maintain a constant electron flux, such an increase in work function requires increasing the temperature and therefore accelerating the evaporation of the wire 21a and thus limiting its lifetime.

To extend the lifetime in such applications, Iridium wire 21a coated with oxide emitters 21b e.g. Thoria and Yttria is used. Iridium, a noble metal with a high melting point, is more resistant to oxidation and other forms of chemical attack than the refractory metals e.g. Tungsten and Rhenium. Yttrium has a lower work function than uncoated refractory metals, so more electrons are emitted at a given temperature, or a given electron emission can be achieved at a lower temperature. The coating 21b is usually applied via an electrophoresis process. The performance of all coated wires (filament) 21 degrades as coating 21b is depleted through evaporation, sputtering away by ion bombardment, and chemical poisoning in the presence of corrosive gases. The lifetime of an yttria-coated iridium filament is based on the evaporation rate or degradation of the coating materials and heater wire; both are temperature and ambient pressure dependent.

The active atoms producing electrons are on the surface or the top few atomic layers of the emitter surface 21b. A typical thickness of the emitter material is around 15 μm or less, at the maximum the thickness may be 25 μm. Electron emission is suppressed when thicker material is used and can only be restored by raising the temperature. During the lifetime of the emitter atoms are slowly lost to the vacuum and get replaced by other atoms, which diffuse from the bulk hence establishing equilibrium between evaporation and diffusion. In the absence of chemical reactions between the emitter and the ambient environment and neglecting ion sputtering, the lifetime is inversely proportional to the rate of evaporation. The rate of evaporation of the emitter material is determined by correlating the rate of weight loss to the vapor pressure.

In the case of bare filaments or filament on which an oxide coating is deposited, as the emitter material 21b evaporates the filament 21 becomes thinner and therefore its resistance increases. The resistance of the filament 21 is derived from the measurement of both the filament current and the voltage across it. By measuring the rate of change of the filament resistance (dR/dt) the time t required for the resistance to reach a critical resistance RL can be computed according to the equation:

t=t₀+(R_{L}−R₀)/(dR/dt)

where R₀ is the cold resistance and t₀ is the time at which dR/dt is measured.

Filament temperatures can be approximated by simply considering the equilibrium between the ohmic heating and heat transfer through radiation. Using Stefan-Boltzmann equation, the measured filament current and voltage, and the physical dimensions of the filament wire the temperature can be calculated and used in the evaporation rate equation.

Some embodiments herein are disclosed as examples of a device including a long lifetime thermo-emission electron ionizer suitable for field applications. The invention represents a novel approach to eliminating the lifetime limitations of such critical components in many chemical analysis instruments including mass spectrometers.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

FIG. 3 shows a preferred embodiment of a device 1 that includes a mass analyzer 10 and a controller 60 that controls the mass analyzer (mass spectrometer) 10 to perform various measurements required by applications. The device 1 may be a system or an apparatus for achieving a specific purpose or various objectives. The mass analyzer 10 is a miniaturized quadrupole type mass spectrometer (mass sensor) that includes an ionizer 50 for generating ions 27 from sample gases 29, a mass filter 30 and an ion detector 35 that is configured to detecting ejected ions from the mass filter 30. The ionizer 50 is a long lifetime thermo-emission electron ionizer that includes an electron generator 51 and an ionization region (ionization space, ionization area) 52 where sampling gases 29 are ionized with electrons 22 supplied by the electron generator 51.

The mass analyzer 10 includes an electrostatic lens (source slit) 25 to supply the ions 27 generated in the ionization region 52 to the mass filter (mass filter region) 30 that is disposed next to the ionization region 52. The mass analyzer 10 further includes a glass chassis 12 that aligns and holds rods 33 of the mass filter 30, pins for electrical connection 14 and a housing 18 that houses and covers the ionizer 50, mass filter 30 and detectors 35 in a state where the sampling gases 29 can pass through.

The mass filter 30 includes a filtering section 31 where the rods 33, for example 4×4 or 3×3 rods 33 are arranged to configure a quadrupole array that acts as a quadrupole mass filter and selects ions by an electrical field. The mass filter 30 may be another type of filter such as an iron trap array, a wien filter, and the like.

One of the aspects of the invention is providing virtually unlimited supply of emitter material by replenishing the reservoir (reserves) as it, evaporates, gets sputtered by positive ions, and/or gets poisoned by ambient corrosive gases. The replenishment of the emitter material is performed on a mechanically extendable solid or fluid emitter core material or array of core materials. In the ionizer 50, the electron generator 51 including a mechanism replenishing the emitter material is provided.

The electron generator 51 includes an electron emitter dispenser 53 that is configured to exposes a limited part 81 of a plurality of bulk bodies 80. The electron emitter dispenser includes a reservoir (reservoir region or space) 54 that is configured to hold the bulk bodies, a propelling mechanism 55 that is configured to expose a limited part 81 of the bulk bodies 80 from the reservoir 54 to face or to be directed to the ionization region 52, and a heater (heating unit) 56 that is configured to heat the exposed limited part 81 of the bulk bodies to emit thermal electrons (thermions) 22.

The dispenser 53 may include one (single) bulk body 80 or an arrayed bulk bodies 80 such as a 2×2 array of four bulk bodies in a matrix-like pattern. The bulk body 80 includes at least one electron emitter material. The emitter materials are often made of low work function materials such as Yttrium Oxide (Y₂O₃), Thorium Oxide (ThO₂), Lanthanum Hexaboride (LaB₆), etc. and mixtures of any of them or alloys of any of them. The bulk body 80 is configured to at least partly depletable and emitting thermal electrons 22 while allowing part of the bulk body to deplete when the heating unit 56 that is configured to heat at least a part of the bulk body 80, heats and rises the temperature of the surface of the bulk body 80.

FIG. 4 depicts an example of a bulk body 80. The bulk body 80 may include a cylindrical like body, a rod like body or a wire like body. The bulk body 80 includes the emitter material 89 in the form of a cylinder, a rod, a sleeve a beam and the like. The bulk body 80 may include high viscosity fluid that can be controlled or operable to expose a limited part. The bulk body 80 may include a thin center wire 83 or rods around which the emitter material 89 is layered, molded, built up or coated via processes such sintering and electrophoresis. The thin center wire 83 may function as electrode such as cathode. In this bulk body 80, the center wire 83 is depletable, that is the center wire may be evaporated with the evaporation of the emitter material 89. A diameter (thickness) of the bulk body 80 may be 10 μm to several tens of mm. Taking a longer lifetime of the bulk body 80 into account, the diameter may be 40 μm to several tens of mm, 100 μm to 10 mm, 500 μm to 10 mm, 1 mm to 10 mm, or up to 5 mm. A length of the bulk body 80 may be several tens of mm or below, or about several mm. The wire type bulk body 80 may be provided with a reel.

The bulk body 80 may consist of a thermionic emitter 89 by sintering a 10:1 or nearly 10:1 nanocomposite mixture of Yttria and Iridium powders. The nanocomposite material produces millions of nano-emitters uniformly distributed within the cathode bulk 80. Such a method circumvents the limitation associated with conventional Yttria coated Iridium filaments where the coating thickness is between 1 and 25 μm and the like. The bulk body 80 may be sintered or dipped with powders of other electron emitter material to form a large number of nano-emitters distributed in the bulk body 80.

In the electron generator 51 of the ionizer 50, the top surface layers of the emitter material 89 of the bulk bodies is heated by the heating unit (heater) 56 to temperatures around or exceeding 1000° C. The heater 56 may be a coil type or a ring type for heating at the end 81 or other part of the bulk body 80. The heating unit 56 may a radiation type that uses radiation e.g. IR or UV to heat a part of the bulk body 80.

As shown in FIG. 3 and FIG. 5, in this embodiment, the heater 56 is a disk plate type including a plurality of apertures 56a, and the tip ends (limited part) 81 of the bulk bodies 80 pass through the apertures 56a respectively and are exposed from the reservoir 54. The heater 56 may function as a separate plate and/or barrier to protect the reserved part of the bulk bodies 80 from the particles and others that may etch or cause depletion. The heater 56 heats only the limited part including the tip 81 of the bulk bodies 80 that passes through the heater 56 and exposed from the reservoir 54 to emit thermal electrons 22. A plate or a barrier may be provided separately from the heating unit 56.

The electron generator 51 of the ionizer 50 includes an electron accelerating anode plate 58 outfitted with a single or an array of apertures 58a. The accelerating anode plate 58 is disposed at the front of the dispenser 53 and the heater 56 to accelerate the electron flow 22 generated from the tip 81 of the bulk bodies 80 to the ionization region 52 to improve ionization efficiency in the ionization region 52. In addition, the accelerating anode plate 58 functions as a wall or a separator that forms a boundary with the ionization region 52.

The acceleration anode plate 58 also functions as a barrier to prevent or suppress intrusion of the ions 27 and the corrosive sampling gases 28, hence the depletion or erosion through evaporation, sputtering away by ion bombardment, and chemical poisoning in the presence of corrosive gases can be suppressed and the lifetime of the bulk bodies 80 can be further expanded. By installing the anode plate 58, even if there is a possibility that the ionization efficiency may decrease due to the fact that the ion source is not directly exposed in the ionization region 52, the ionization efficiency is improved by the ion flow accelerated by the acceleration anode plate 58.

The ionizer 50 may include an anode plate 41 and a magnet field generator 43 to surround at least a part of the ionization region 52 to make long electron trajectory to improve the ionization efficiency.

The electron generator 51 of the ionizer 50 includes a holder 57 that is configured to hold the bulk bodies 80 to prevent direct exposure of the sampling gases 29 in the ionization region 52. That is, the holder 57 holds the bulk bodies 80 behind the acceleration anode plate 58 to hold the bulk bodies 80 within the electron generator 51 not to extrude from the electron generator 51.

The holder 57 is also configured to hold the bulk bodies 80 so that an end (tip end) 81 of each bulk body 80 is directed to the ionization region 52 and another end (base end) 82 of each bulk body 80 is not directed to the ionization region 52. Due to this configuration, the bulk bodies 80 are partly depleted or evaporated step by step from the tip end 81 and the consumed process of the bulk bodies 80 can be easily controlled.

The propelling mechanism 55 of the dispenser 53 is configured to expose the limited part including a tip end 81 of the bulk bodies 80 to an electron generation area 59 that may be the region between the heater 56 and the acceleration anode plate 58. In another embodiment, the dispenser 53 may be installed in the ionization region 52 to directly supply the electrons 22 in the ionization region 52. In such embodiment, the limited part 81 of the bulk bodies 80 may be exposed in the ionization region 52.

In this electron generator 51, the propelling mechanism 55 controls the position of bulk bodies 80 via the holder 57 synchronously or integrally. In the other embodiment, the propelling mechanism 55 may propel or control a position of each bulk body 80 according to a depletion rate, an evaporation rate or ion current of each bulk body 80 or a distribution of electron emission flux.

One of preferred mechanism of the propelling mechanism 55 may consist of using a magnetic field generated by a solenoid at the base (base frame) 51a of the structure of the electron generator 51 to keep advancing the bulk bodies 80. The propelling mechanism 55 may include a variable magnetic field generated by a solenoid or an equivalent device, to control the propulsion of the bulk bodies 80 such as formed as the emitter rods. The propelling mechanism 55 may include various mechanism that can move the holder 57 in the electron generator 51 or from outside of the generator 51 such as a piezoelectric device, a cylinder, a motor and others.

Other various embodiments in this disclosure rely on various propelling mechanisms 55. The mechanism types are considered to propel the emitter material in the form of bulk body 80 such as a rod, sleeve, a beam, high viscosity fluid etc. Such mechanisms 55 may further include: twisting a screw which moves a slider down the barrel, an automated clutch mechanism to incrementally advance the material, or a spring-loaded pushing mechanism that is activated to deplete part of the bulk body 80.

The automation can be performed incrementally and/or following a command from sensing of the electron emission flux. The controller 60 of the device 1 includes an operating unit (ion drive circuitry, ionizer control unit) 61 that is configured to operate the ionizer 50 at various temperatures and/or various electron energies. The ionizer control unit 61 includes a monitoring unit 61a that is configured to monitor and control an emission current Ea and an emission voltage Ev to stabilize the performance of the electron generator 51 so as to keep the amount of ions inputted into the filter unit 30 which can be kept effectively constant. This means that the amounts of the various ions separated by the filter unit 30 and detected at the detector unit 35, that is, the content (content ratios, proportions) of the gases 29, can be quantitatively determined with high precision.

The ionizer control unit 61 further includes a bulk body position control unit 61b, a heater control unit 61c and an accelerating anode control unit 61d. The position control unit 61b is configured to propel, using the propelling mechanism 55, the bulk body 80 at a certain rate which depends on the depletion rate of the bulk body 80, propel the bulk bodies upon command from the processor 70, propel the bulk bodies 80 based on external information such as the Emission current Ea, which indicates depletion of an exposed limited part of the bulk body 80. The heater control unit 61c is configured to adjusting a temperature of the exposed part 81 of the bulk bodies 80 to provide a constant flux of electrons. The anode control unit 61d is configured to control the voltage of a surface of the bulk bodies Ev and a voltage Av of the accelerating anode 58 to set or scan an electron energy generated by the electron emitter dispenser 53.

The monitoring unit 61a measures an box (frame) current or an anode plate current, for example, the emission current Ea and controls the bulk voltage (cathode voltage) Ev, propelling of the bulk bodies 80 from the dispenser 53 and/or heating temperature of the bulk bodies 80 to stabilize the emission current Ea that shows the electron flow 22 to the ionization zone 52. For example, if the emission current Ea is decreased due to the depletion of the exposed part 81 of the bulk bodies 80, the ionizer control unit 61 controls the propelling mechanism 55 of the dispenser 53 to advance the bulk bodies 80 to expose the sufficient part or volume of the bulk bodies 80. Hence the dispenser 53 can replenish the reserves for depletion or evaporation to the depleted or evaporated part and provide virtually unlimited supply of emitter material 89. That is, the emitter material 89 supplied as the bulk body 80 is not bonded to the outer casing such as frame 51a of the electron generator 51 or the ionizer 50, and the bulk body 80 can be mechanically or electromagnetically and automatically extended as the material on the top front surface layers is depleted or evaporated during a thermo-emission process in vacuum.

The electron generator 51 may be provided as a modular component 100 that includes at least one electron emitter dispenser 53, the accelerating anode plate 58 and the control unit 61 that performs detection and emission control of the electron generation.

The device 1 may comprise a modular component (emitter module) 100 for electron generation that includes at least one electron emitter dispenser and detection including circuitry for emission control of the electron generation.

FIG. 6 (a)-(c) depict emitter modules 100 in various in various embodiments for different ionizer geometries. Each emitter module 100 is surrounded by the frame 51a of the electron generator 51 and the acceleration anode plate 58 with array of apertures 58a. One or more emitter modules 100 may be integrated in the device 1 or may be additionally adopted to the conventional mass spectrometer.

The controller (control unit, control board) 60 communicates with the ionizer 50, the mass filter 30 and the ion collector 35 of the mass analyzer 10 via the pins for electrical connection 14 for controlling the mass analyzer 10 and acquiring data or information from the mass analyzer 10 to perform various measurements. The controller 60 includes the ionizer control unit 61, an ion drive circuit 62 that electrically drives the conventional ionization unit 20 that is optionally installed in the ionization region 52, a field drive circuit 63 that electrically drives the filter unit (mass filter) 30, a detector circuit 64 that controls the sensitivity of the detector unit 35, the processor 70 for operating the device 1, memory 73, a communication module 76 and a user interface 77. The controller 60 may be a user of the mass analyzer 10 to use an output from the mass analyzer 10.

The field drive circuit 63 is configured to electrically drive the quadrupole field of the quadrupole array 33 of the filtering section 31 using RF (frequency) and DC.

The processor 70 is a system such as a CPU, a microcontroller, a signal processor, a field-programmable gate array (FPGA) and the like. In the processor 70, applications 79 and functional modules 71 and 72 supplied by programs (computer program, program products, software) 74 stored in the memory 73 such as ROM that is one of non-transitory computer readable mediums, are implemented. The programs 74 includes executable codes for performing functions and algorithm of the applications 79 and modules 71 and 72 by the processor 70. The processor 70 includes an ionizer control module 71 and an analyzing filter control module 72. The analyzing control module 72 controls over all functions of the mass spectrometer 10. The ionizer control module 71 controls ionizer 50 under the control of the module 72.

The control module 71 includes a module 71a that is configured to propel the bulk body 80 in the dispenser 53 automatically at a certain rate, continuously or intermittently, which depends on the depletion rate of the bulk body 80; a module 71b that is configured to send a command for propelling the bulk body 80 to the dispenser 53 via the control unit 61 when, for example, the application 79 requests detection in more severe conditions and/or more precise results; a module 71c that is configured to propel the bulk body 80 based on external information which indicates depletion of an exposed limited part of the bulk body 80 such as a decreasing of the electron flow 22 is suggested by the detection results of the mass spectrometer 10; a module 71d that is configured to adjust a temperature of the exposed limited part of the bulk body 80 to provide a constant flux of electrons; module 71e that is configured to control the voltage Ev of a surface of the bulk body 80 and the voltage Av of the accelerating anode 58 to set or scan an electron energy generated by the electron emitter dispenser 53; and a module 71f that is configured to operate the electron generator 51 as standalone device or interfaced with existing ion source 20 if installed in the ionizer 50, providing electron acceleration voltages to the existing ion source 20.

The application 79 may control the mass analyzer 10 to perform the required search and output the result of searches using the communication unit 76 and the user interface (U/I) 77. U/I 77 is one of output units that may include a display for outputting measurement results relating to the sample gases 29, a touch panel for setting conditions of measurement to be performed by the mass analyzer 10, and audio equipment for outputting alarms. The communication unit 76 is another one of output units that may be connected by wire or by way of an appropriate wireless communication technology, such as Wi-Fi connection, wireless LAN, cellular data connection, Bluetooth(R) or the like to an external system via the Internet or other computer networks to monitor and/or remote control the device 1.

FIG. 7 is a flow diagram that illustrates a process for scanning a set of m/z to measure or monitor compositions of the sample gases 29 using the device 1. In this device 1, ionizing by the ionizer 50 at step 110, and filtering and detecting by the filtering section 30 and detector 35 at step 120 are processed in parallel. At step 110, the ionizing that includes emitting thermal electrons is performed using the electron generator 51 with allowing a part of the bulk body 80 to deplete. At step 112, tuning of the ionizer 50 is required, at step 113, the position control unit 61b controls the dispenser 53 to expose a limited part 81 of the bulk bodies 80. At step 113, if the emission current Ea is not sufficient, the position control unit 61b controls the propelling mechanism 55 to advance a dispending of the bulk bodies 80.

At step 114 and 115, the ionizer 50 is operated at the same or different temperatures and electron acceleration voltages. At step 114, the heater control unit 61c controls the heater 56 to keep the temperature of the surface of the part of the bulk bodies exposed from the reservoir 54 or, if necessary, increases or decreases the surface temperature of the bulk bodies 80. At step 115, the anode control unit 61d controls the voltage of a surface of the bulk bodies Ev and the voltage Av of the accelerating anode 58 to eject sufficient electron flux 22 to the ionization region 52. In this step 115, at least one aperture 58a of the accelerating anode plate 58 is used for defining electron beams 22 toward the sample gases ionization region 52.

At step 116, if a cooperative control is required, the electron generator 51, which is usually operated as a standalone device, is operated with the existing ion source 20 to provide the electron acceleration voltages.

FIG. 8 illustrates another embodiment of a device in accordance with the invention.

The device 1 includes a mass analyzer 10a that is also a miniaturized quadrupole type mass spectrometer (mass sensor). The mass analyzer 10a includes an ionizer 50, an electrostatic lens 25, a mass filter 30, and an ion detector 35, which are integrated and enclosed. The ionizer 50 includes an electron generator 51. The electron generator 51 includes a bulk cathode 87 that includes a bulk body 80 integrated with a coiled filament 88 that functions as a heater, and an accelerating anode plate 58 with an aperture 58a to define electron beams 22 toward a sample gases ionization region 52. The coiled heater 88 holds the bulk body 80 so that an end 81 is directed to the ionization region 52 and another end 82 is not directed to the ionization region 52.

The ionization region 52 is enclosed by an anode 41 and permanent magnets 43 are disposed around the ionization region 52 to produce a long electron trajectory 45 in the ionization region 52. To provide a long-life electron generator (electron emitter) 51, in this embodiment, the bulk cathode 87 is placed outside the ionization region 52 and in an enclosure shielded from the ionization region 52 to prevent direct exposure of the sample gases 29 and the sample gases are directly injected to the ionization region 52. The electron current Ea is controlled smaller to less ion damage, and to compensate the sensitivity due to the smaller electron current, long electron trajectory is kept in the ionization region 52. A permanent magnet around the ionization region 52 produces a magnetic field giving electrons a long helical motion increasing their ionization efficiency. In addition, for extending the life of the bulk cathode 87, bulk sintered emitter material, such as Yttria (Y₂O₃) or a mixture of Yttria and Iridium (Ir), is used.

The device 1 includes the ionization region 52 disposed next to the ionizer (electron generator) 51 and the mass filter region 30 disposed next to the ionization region 52. Sample gases 29 are injected to the ionization region 52 directly and ionized by electrons emitted by the generator 51 indirectly. The ionization region 52 includes an anode 41 and a magnet field 43 to make long electron trajectory 45 and hence increase ionization efficiency to compensate sensitivity. Efficient ionization sources require lower electron flux and therefore last longer since the ionizer 50 operates at lower temperatures and damage from ion sputtering is reduced.

FIG. 9 illustrates a test system 150 of the bulk cathode 87. The test system 150 includes a vacuum chamber 152 in which the bulk cathode 87 is installed, a turbo pump 153, an emission current detector 155 and a circuity to detect an emission current Ea and an Emission voltage Ev.

FIG. 10 shows an example of electron emission recorded from a bulk cathode 87. A line 161 shows a pressure in the test chamber 152, a line 163 shows the emission current Ea, a line 165 shows a center wire voltage of the bulk cathode 87 and a line 167 shows a center wire current of the bulk cathode 87. In this measurement, a heater voltage of the heater coil (coiled filament) 88 is 14V, a heater current is 1.3 A and an extractor voltage is 250V. The bulk cathode 87 includes one of preferred emitter materials of Yttria:Iridium (10:1) sintered as a laboratory prototype bulk cathode of about 4 mm in diameter is used. The activation time is measured to be about 7 Hours. Emission current in excess of 3 mA/cm² was obtained at an operating temperature of 1000° C. The lifetime of this cathode is anticipated to be in excess of 2000 hours in corrosive environments where etch rates are estimated at 1 nm/min.

In the above, although the embodiments are described with reference to the mass analyzer having the quadrupole mass filter 30, the mass analyzer may be equipped with other type of mass filter using electric and/or magnetic field such as a wien filter and the like, with a ion trap using electric and/or magnetic field such as a penning trap and the like. It is understood that other implementations may be utilized and structural changes may be made without departing from the scope of the present disclosure.

The method of the emitter dispenser 53 described in this disclosure eliminates the limitation associated with ionizer lifetime and therefore enhances the reliability and dependability of field analytical devices 1 and fully integrated devices intended for continuous monitoring and control. The combination of such ionizer 50 with Faraday detectors 35 eliminates the utilization of consumables and provides virtually unlimited lifetime. Non-consumable components such as the ionizer 50 provide chemical analysis instruments such as mass spectrometers and other charged particle analyzers with: 1. Needed robustness, 2. Infinite lifetime, and 3. Lack of maintenance. Such attributes are critical for reliable, autonomous operation in the field.

Charged particles analyzers used for chemical analysis often rely on ionizing the sample using an electron beam. As these are becoming more ubiquitous in field applications there are pressing needs for reliable long-lasting ionizers. Fully integrated devices into a wide range of manufacturing process tools e.g. pharmaceuticals, semiconductor chip manufacturing, food processing, and petrochemicals are relied upon for continuous real-time monitoring and process control. Autonomy, dependability, and low maintenance are key requirements to minimizing downtime and hence increasing tool availability.

The limited lifetime of the ionizer is intimately to the depletion of the emitter material due to pure evaporation at the high temperatures required to release electrons into the vacuum. The rate of evaporation increases at higher temperatures. Neglecting workmanship issues and environmental stresses, other factors accelerating the depletion of the emitter material include:

1. sputtering of the emitting surface by positive ions created by accelerated electrons. Such a mechanism of failure is exacerbated at high ambient pressures.

2. poisoning by chemical reactions between the hot emitter and the ambient gases. For example, oxide emitters e.g. ThO₂ and Y₂O₃are depleted in a chemically reducing environment. A pure metal emitter such as Tungsten sees its work function (the energy required to cause the electrons to jump from the valence bond to the continuum) increase in an oxidizing environment hence forcing the emitter to operate at higher temperatures to produce a constant electron emission flux.

3. etching of the surface by corrosive gases. Such a mechanism of failure is severe as it limits the lifetime drastically due to the aggressive nature of gases such as Chlorine and Fluorine which are very common in a long list of semiconductor manufacturing processes.

In the present invention, a novel ionizer with virtually infinite lifetime suitable for various charged particles analysis platforms is disclosed. The invention represents a practical approach to extending the lifetime of the ionizer and providing the robustness and the reliability required for long lasting field operation and the dependability required for real time monitoring and process control. The device and method include modular components to operate the ionizer as a standalone or as a retrofit component for existing ion sources. The ionizer or bulk cathode relies on a dispenser of emitter material or nano-emitters obtained via a sintering process. The bulk cathode is automatically propelled as the top layers are depleted through evaporation, sputtering, and/or poisoning. In a preferred embodiment an array of emitter is assembled in a structure outfitted with heating mechanisms of the tip of the emitter material, propelling mechanisms for advancing the emitter material, and electron accelerating anode plate. The propelling of the emitter material is computer controlled via algorithms executing incremental advancements based on evaporation rates of the emitter material and/or in response to the desire to achieve a certain electron emission level.

One of the aspects of the above is a device including an ionizer that comprises at least one electron emitter dispenser. The device may comprise an assembly of modular components including: (a) a structure to hold the reservoir of emitter material; (b) a Heating mechanism at a tip of the assembly where a tip of the emitter material is exposed; (c) a Propelling mechanism that exposes a limited part including the tip of the emitter material; and (d) an accelerating anode plate outfitted with a single or an array of apertures.

In one of the aspects of the above, the device and method rely on providing virtually unlimited supply of emitter material by replenishing the reservoir as it, evaporates, gets sputtered by positive ions, and/or gets poisoned by ambient corrosive gases. The replenishment of the emitter material is performed on a mechanically extendable solid or fluid emitter core material or array of core materials. The emitter, often made of low work function material such Yttrium Oxide (Y₂O₃), Thorium Oxide (ThO₂), Lanthanum Hexaboride (LaB₆) etc., is not bonded to the outer casing, and can be mechanically or electromagnetically extended as the material on the front surface layers is depleted during a thermo-emission process in vacuum. The top surface layers of the emitter material is heated to temperatures exceeding 1000° C. using a ring at the end of the sleeve or using radiation e.g. IR or UV. Various embodiments in this disclosure rely on various propelling mechanisms. The mechanism types are considered to propel the emitter material in the form of a rod, sleeve, a beam, high viscosity fluid etc. Such mechanisms may include: twisting a screw which moves a slider down the barrel, automated clutch mechanism to incrementally advance the material, or a spring-loaded pushing mechanism that is activated as the emitter material is depleted. A preferred mechanism consists of using a magnetic field generated by a solenoid at the base of the structure to keep advancing the rod. The automation can be performed incrementally and/or following a command from a sensor of the electron emission flux.

The device may further comprise an operating unit that is configured to operate the ionizer at various temperatures and various electron energies. The device may further comprise a modular component for electron generation that includes at least one electron emitter dispenser and detection including circuitry for emission control of the electron generation. The at least one electron emitter dispenser may include a structure to hold an emitter material to prevent direct exposure of sampling gases. The at least one electron emitter dispenser may include a bulk cathode.

Another aspect of the above is a device including a bulk cathode. The bulk cathode may be a bulk sintered cathode, a bulk dipped cathode and the like. The device may include a structure to hold an emitter material to prevent direct exposure of sampling gases. The bulk cathode may include a coiled filament and a cylindrical like bulk emitter material integrated with the coiled filament. One of ends of the cylindrical like bulk emitter material may be directed to an ionization region and the other end of the cylindrical like bulk emitter material may not be directed to the ionization region. A preferred device and method for a bulk cathode consist of a thermionic emitter by sintering or dipping a 10:1 or nearly 10:1 mixture of Yttria and Iridium powders. The nanocomposite material produces millions of nano-emitters uniformly distributed within the cathode bulk. Such a method circumvents the limitation associated with conventional Yttria coated Iridium filaments where the coating thickness is between 1 and 25 μm.

The device may further comprise an ionization region disposed next to the ionizer and a mass filter region disposed next to the ionization region, wherein sample gases are injected to the ionization region directly and ionized by electrons emitted by the ionizer. The ionization region may include an anode and a magnet field to make long electron trajectory.

Yet another aspect of the above is a method including ionizing gasses using an ionizer comprising at least one electron emitter dispenser. The ionizer includes: (a) a structure to hold the reservoir of emitter material; (b) a Heating mechanism at a tip of the assembly where a tip of the emitter material is exposed; (c) a Propelling mechanism that exposes a limited part including the tip of the emitter material, and (d) an accelerating anode plate outfitted with a single or an array of apertures and wherein the ionizing may include using the propelling mechanism to advance a dispending of the emitting material for extended lifetime. The ionizing may include operating the ionizer at the same or different temperatures and electron acceleration voltages. The ionizing may include using at least one aperture for defining electron beams toward a sample ionization region. The method may further comprise operating as standalone device or interfaced with existing ion source providing electron acceleration voltages.

Yet another aspect of the above is a non-transitory computer readable medium storing software for controlling emitter propelling mechanisms, emitter temperature, electron acceleration energies, the software comprising: (a) executable algorithm that controls incremental propelling the emitter material at a certain rate which depends on the evaporation rate of the emitting material; (b) executable code that controls propelling the emitter material based on external information which indicates depletion of the top layer of the emitter; (c) executable closed loop code that adjusts the temperature of the emitter material to provide a constant flux of electrons; and (d) executable code that controls at least one voltage on either the face of the emitter or the accelerating anode or both to set or scan the electron energy. The software may further comprise executable code that controls operations regarding at least two operational modes corresponding to advancements of the emitter material either incrementally or upon command.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

1. A device including an ionizer that comprises:
at least one bulk body including at least one electron emitter material and that is configured to at least partly depletable; and
a heating unit that is configured to heat at least a part of the at least one bulk body.

2. The device according to claim 1, wherein the ionizer further comprises at least one electron emitter dispenser, each electron emitter dispenser being configured to exposes a limited part of the at least one bulk body.

3. The device according to claim 2, wherein the electron emitter dispenser includes:
a reservoir configured to hold the at least one bulk body; and
a propelling mechanism configured to expose a limited part of the at least one bulk body, wherein the heating unit is configured to heat the limited part of the at least one bulk body.

4. The device according to claim 3, wherein the propelling mechanism is configured to expose the limited part including a tip of the at least one bulk body, and the heating unit is configured to heat the tip of the at least one bulk body.

5. The device according to claim 2, further comprising a modular component for electron generation that includes at least one electron emitter dispenser and detection including circuitry for emission control of the electron generation.

6. The device according to claim 1, wherein the ionizer further comprises an accelerating anode plate outfitted with a single or an array of apertures.

7. The device according to claim 1, wherein the ionizer further comprises an ionization region where sampling gases are ionized with electrons generated by the at least one bulk body.

8. The device according to claim 7, wherein the ionization region includes an anode and a magnet field to make long electron trajectory.

9. The device according to claim 7, wherein the ionizer further comprises a holder configured to hold the at least one bulk body to prevent direct exposure of the sampling gases.

10. The device according to claim 7, wherein the ionizer further comprises a holder configured to hold the at least one bulk body so that an end of the at least one bulk body is directed to the ionization region and another end of the at least one bulk body is not directed to the ionization region.

11. The device according to claim 2, further including a mass filter region disposed next to the ionization region.

12. The device according to claim 1, wherein the at least one bulk body is sintered or dipped with powders of the at least one electron emitter material to form a large number of nano-emitters distributed in the at least one bulk body.

13. The device according to claim 1, wherein the at least one bulk body includes at least one bulk cathode that includes a bulk body integrated with a coiled filament.

14. The device according to claim 1, wherein the at least one bulk body includes a cylindrical like body, a rod like body or a wire like body.

15. The device according to any claim 1, further including an operating unit that is configured to operate the ionizer at various temperatures and/or various electron energies.

16. A method comprising ionizing gasses using an ionizer that comprises at least one bulk body including at least one electron emitter material and a heating unit for heating at least a part of the at least one bulk body,
wherein the ionizing includes emitting thermal electrons with allowing a part of the at least one bulk body to deplete.

17. The method according to claim 16, wherein the ionizer further comprises at least one electron emitter dispenser for holding the at least one bulk body,
wherein the ionizing further includes exposing a limited part of the at least one bulk body using the at least one electron emitter dispenser.

18. The method according to claim 17, wherein the at least one electron emitter dispenser includes a structure to hold the at least one bulk body and a propelling mechanism that exposes the limited part of the at least one bulk body,
wherein the exposing includes using the propelling mechanism to advance a dispending of the at least one bulk body.

19. The method according to claim 16, wherein the ionizing further includes operating the ionizer at the same or different temperatures and electron acceleration voltages.

20. The method according to claim 16, wherein the ionizing includes using at least one aperture for defining electron beams toward a sample gases ionization region.

21. The method according to claim 16, further comprising operating the ionizer as a standalone device or interfaced with existing ion source providing electron acceleration voltages.

22. A computer program product for a computer to operate a device including an ionizer that comprises at least one electron emitter dispenser for dispensing a limited part of at least one bulk body including at least one electron emitter, wherein the computer program includes executable codes for performing at least one of steps of:
propelling the at least one bulk body at a certain rate which depends on the depletion rate of the bulk body;
propelling the at least one bulk body upon command;
propelling the at least one bulk body based on external information which indicates depletion of an exposed limited part of the at least one bulk body;
adjusting a temperature of the exposed limited part of the at least one bulk body to provide a constant flux of electrons; and
controlling at least one of a voltage of a surface of the at least one bulk body and a voltage of an accelerating anode to set or scan an electron energy generated by the at least one electron emitter dispenser.
